(19) United States
(12) Patent Application Publication
(10) Pub. No.: US 2007/0082965 A1
(43) Pub. Date: Apr. 12, 2007

(54) Photocuring resin composition, medical device using same and method for manufacturing same

(75) Inventors: Kyouyu Yasuda, Tokyo (JP); Yasuaki Yokoyama, Tokyo (JP); Michiko Yokoyama, Mie (JP); Naomi Shinoda, Aichi (JP); Risa Yokoyama, Mie (JP); Nobuo Bessho, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR Corporation, Tokyo (JP)

(21) Appl. No.: 10/536,909

(22) PCT Filed: Nov. 13, 2003
(86) PCT No.: PCT/JP03/14440

§ 371 Date: Mar. 6, 2006

(30) Foreign Application Priority Data
Nov. 28, 2002 (JP) 2002-345526
Feb. 12, 2003 (JP) 2003-33152

(51) Int. Cl. C08G 59/68

(52) U.S. Cl. 522/15

(57) ABSTRACT

It is an object of the present invention to provide a novel photo-curing composition which can be cured by light of a wide wavelength region including ultraviolet light or visible light, has such high sensitivity that it can be sufficiently cured by exposure to a small amount of light, can favorably form a fine pattern when used as a resist and provides a cured product having excellent heat resistance and insulating properties, and a negative photoresist composition using the photo-curing composition. It is another object of the present invention to provide a process for highly accurately and easily producing a polyimide thin film used for a medical instrument, and a medical instrument having the polyimide thin film. The photo-curing composition of the present invention comprises (A) a carbon cluster and/or its derivative, having a photosensitizing function, (B) a compound having plural heterocyclic rings in a molecule, and if necessary, (C) a photo-insensitive resin.

### TECHNICAL FIELD

The present invention relates to a photo-curing resin composition which uses a carbon cluster as a sensitizing agent, can be favorably used as a negative (crosslinked) photoresist composition and can be also used as a material for forming a coating film for various members such as medical instruments, and uses of the composition. The present invention also relates to a medical instrument having a polyimide thin film layer used for medical image fibers, medical catheters, medical tubes, bags, etc., and a process for producing the medical instrument.

### BACKGROUND ART

In the manufacture of semiconductor devices or the like, pattern formation comprising forming a thin film of a resist composition on a substrate, irradiating the thin film with light, radiation or the like and then developing the film is generally carried out.

As a photoresist of negative type that is crosslinked by means of light, radiation or the like, a mixture of a photo radical generator, such as stilbazole modified polyvinyl alcohol or benzophenone, and a polyacrylate is known. This resist can be cured by irradiating it with a light source such as g line (436 nm) or i line (366 nm).

However, with fining of semiconductor devices in their sizes and promotion of integration of patterns, resists capable of highly accurately forming finer patterns have been desired, and development of photosensitive compositions of higher sensitivity and higher resolution has been desired.

Under such circumstances as mentioned above, resists using fullerene have been proposed. For example, in Japanese Patent Laid-Open Publication No. 167812/1994, a composition containing fullerene and a photosensitive agent such as an azide compound is described. In Japanese Patent Laid-Open Publication No. 19136/1994, it is described to use, as a resist, fullerene added with a photosensitive group such as a methacrylamide group. In these publications, further, it is disclosed that the fullerene exhibits excellent effect when X-rays or electron rays are used. Further, in Japanese Patent Laid-Open Publication No. 62105/1995, it is disclosed that a copolymer of fullerene and organosilane, said copolymer having fullerene in its main chain, functions as a photosensitive resin because the copolymer has a silicon atom in the main chain. In Japanese Patent Laid-Open Publication No. 282649/1998 and Japanese Patent Laid-Open Publication No. 109613/1999, it is disclosed that by the addition of fullerene to a resist containing a resin and a photosensitive agent, exposure of the resulting resist can be favorably carried out using light of a short wavelength, and etching resistance, resolution, etc. of a resist film can be improved. These resists, however, need to be exposed by irradiation with electron rays, radiations or light of short wavelength. Accordingly, resists capable of being exposed favorably by irradiation with ultraviolet rays or visible light have been desired from the viewpoints of apparatus cost and safety.

On the other hand, in Japanese Patent Laid-Open Publication No. 134413/1995, it is disclosed to use, as a resist, a thin film of fullerene itself that is piled on a wafer by thermal sublimation, and it is described that exposure is carried out by the use of UV light having a main wavelength region of 365 nm to 405 nm as a radiation source. In this method, however, there is a problem that a resist film cannot be formed by coating.

Further, Japanese Patent Laid-Open Publication No. 90893/1998 proposes, as a fullerene-containing resist which undergoes reaction upon irradiation with ultraviolet light or visible light, a resist which is cured by a mechanism that fullerene acts as a crosslinking agent for a resin to form fullerene crosslinking.

In Japanese Patent Laid-Open Publication No. 214585/2000 and Japanese Patent Laid-Open Publication No. 338668/2000, a photosensitive resin composition comprising polyamic acid or polyamide represented by a specific formula and fullerene is proposed, and in Japanese Patent Laid-Open Publication No. 323037/2001, a photo thermosetting resin composition comprising a polyfunctional epoxy resin, specific phenolic novolak and fullerene is proposed.

In the case where fullerene having no hydrophilic group such as unsubstituted fullerene is used as a resist component in such fullerene-containing resists as mentioned above, it is necessary to use, as a resist solvent, a specific solvent that dissolves fullerene.

Under such circumstances as described above, development of a novel photo-curing composition which undergoes reaction upon irradiation with ultraviolet light or visible light, is employable as a negative resist composition, has high sensitivity and can provide a cured product having excellent heat resistance and insulating properties has been desired.

On the other hand, because polyimide resins have properties of high heat resistance, high strength and high biocompatibility, application of such polyimide resins to constituent members of medical instruments has been developed in various fields.

The polyimide resins, however, have poor processability because they are insoluble in solvents. Polyimide precursors are soluble in solvents, but in order to form polyimide resins, a step of baking the precursors at high temperatures is necessary. Further, although there is no fear of contamination in the formation of polyimide resins by vapor evaporation polymerization, they are materials awkward to process into thin films, for example, they need a vacuum process, so that it is difficult to apply such polyimide resins to medical instruments.

The polyimide resins are widely recognized as insulating materials in the electronic material applications, and a large number of photosensitive polyimides capable of forming thin films and capable of being readily patterned have been proposed.

As the photosensitive polyimides, positive type and negative type have been proposed, and in either case, low-molecular compounds, such as photosensitive agents (e.g., photo acid generator, photo radical generator, photo cation generator) and various sensitizers, are employed.

In the uses for medical purpose, however, there is a fear of toxicity due to elution of products formed by light modification of the low-molecular compounds or elution of unreacted residues, and therefore, these compounds have not been used heretofore for the medical purpose.

Recently, however, negative photosensitive polyimide of new type using a slight amount of fullerene as a photosensitive agent has been proposed (Japanese Patent No. 2878654). This negative photosensitive polyimide is based on an entirely new mechanism that fullerene excites oxygen upon exposure to light and the excited oxygen causes polycondensation of furan rings to crosslink the polyimide, and it is thought that the following contributes to low toxicity. That is to say, fullerene that plays a roll of a photosensitive agent does not change chemically and stays in the cured resin. The excited oxygen has a short lifetime, so that excited oxygen having been not consumed for the polycondensation of furan rings is deactivated. Therefore, the possibility of elution of a toxic component from a resin formed by photo-curing of the photosensitive polyimide resin is extremely low, and use of such a photosensitive polyimide resin for medical instruments is expected.

It is an object of the present invention to provide a novel photo-curing composition which can be cured by light of a wide wavelength region including ultraviolet light or visible light, has such high sensitivity that it can be sufficiently cured by exposure to a small amount of light, can favorably form a fine pattern when used as a resist and provides a cured product having excellent heat resistance and insulating properties, and a negative photoresist composition using the photo-curing composition.

It is another object of the present invention to provide a process for highly accurately and easily producing a polyimide thin film used for a medical instrument, and a medical instrument having the polyimide thin film.

### DISCLOSURE OF THE INVENTION

The photo-curing composition according to the present invention is a photo-curing composition comprising:

(A) a carbon cluster and/or its derivative, having a photosensitizing function,

(B) a compound having plural heterocyclic rings in a molecule,

and if necessary,

(C) a photo-insensitive resin.

The “photo-insensitive resin” means a resin that undergoes no oxidation polycondensation reaction and is, for example, a high-molecular compound having no heterocyclic ring in a molecule.

It is preferable that the photo-curing composition of the present invention contains a compound having a siloxane bond in a molecule, and it is more preferable that at least one of the carbon cluster and/or its derivative (A), the compound (B) having heterocyclic rings in a molecule and the photo-insensitive resin (C) contains a compound having a siloxane bond in a molecule. In such a photo-curing composition of the present invention, the compound having a siloxane bond in a molecule is preferably contained in an amount of 1 to 30% by weight in the photo-curing composition except a solvent.

In the photo-curing composition of the present invention, the carbon cluster and/or its derivative (A) preferably contains one or more substances selected from the group consisting of fullerene, carbon nanotube, carbon nanohorn and their derivatives.

In the photo-curing composition of the present invention, the carbon cluster and/or its derivative (A) preferably contains one or more substances selected from the group consisting of fullerene and fullerene derivatives.

In the photo-curing composition of the present invention, the carbon cluster and/or its derivative (A) preferably contains chemically modified fullerene.

In the photo-curing composition of the present invention, the carbon cluster and/or its derivative (A) preferably contains a derivative of a carbon cluster having a heterocyclic ring.

In the photo-curing composition of the present invention, the total amount of fullerene and a fullerene derivative is preferably in the range of 50 to 100 parts by weight in 100 parts by weight of the carbon cluster and/or its derivative (A).

In the photo-curing composition of the present invention, the compound (B) having plural heterocyclic rings in a molecule preferably contains a polymer having a heterocyclic ring in a side chain. In such a photo-curing composition of the present invention, the polymer having a heterocyclic ring in a side chain is preferably a polymer obtained by allowing a polymer selected from the group consisting of an acrylic-based polymer, an epoxy-based polymer and a polyimide-based polymer to react with a compound having a heterocyclic ring, and is also preferably a polymer which is obtained by allowing a polyimide-based polymer to react with a compound having a heterocyclic ring and has a heterocyclic ring at least one end.

In the photo-curing composition of the present invention, the compound (B) having plural heterocyclic rings in a molecule preferably contains a compound having a molecular weight of 200 to 100,000.

In the photo-curing composition of the present invention, the compound (B) having plural heterocyclic rings in a molecule is preferably a compound having furan rings and/or thiophene rings as the heterocyclic rings.

In the photo-curing composition of the present invention, the compound (B) having plural heterocyclic rings in a molecule is preferably a heterocyclic ring-containing polyimide resin.

In the photo-curing composition of the present invention, the photo-insensitive resin (C) preferably contains a polyimide resin.

The negative photoresist composition according to the present invention comprises the above-mentioned photo-curing resin composition of the present invention.

The process for producing a medical instrument according to the present invention comprises applying the photo-curing composition of the present invention, in which at least one of the carbon cluster and/or its derivative (A), the compound (B) having heterocyclic rings in a molecule and the photo-insensitive resin (C) contains a polyimide resin, or the photo-curing composition of the present invention, in which the compound (B) having heterocyclic rings in a molecule is a heterocyclic ring-containing polyimide resin, on a substrate and then irradiating the composition with light to form a coating layer having a thickness of 1 to 1000 μm.

The medical instrument according to the present invention is obtained by the process for producing a medical instrument according to the present invention.

### DETAILED DESCRIPTION OF THE INVENTION

The present invention is described in detail hereinafter.

The photo-curing composition of the present invention comprises (A) a carbon cluster and/or its derivative, having a photosensitizing function, (B) a compound having plural heterocyclic rings in a molecule, and if necessary, (C) a photo-insensitive resin. The “photo-insensitive resin” means a resin which undergoes no oxidation polycondensation reaction and is, for example, a high-molecular compound having no heterocyclic ring in a molecule.

### (A) Carbon Cluster and/or its Derivative

The carbon cluster and/or its derivative (A) employable in the present invention has a photosensitizing function. The “photosensitizing function” means a function of imparting energy to oxygen molecules upon irradiation with light to generate singlet oxygen (¹O₂)

As the carbon cluster and/or its derivative (A), there can be employed any of substances having a photosensitizing function among fullerenes, single-layer carbon nanotubes, multilayer carbon nanotubes, carbon clusters having less than 60 carbon atoms and derivatives obtained by chemically modifying these carbon clusters.

Examples of the fullerenes include C₃₆, C₆₀, C₇₀, C₇₆, C₇₈, C₈₂, C₈₄, C₉₀, C₉₆ and higher fullerene wherein the number of carbon atoms in one molecule exceeds 96 and the maximum aggregate diameter is not more than 30 nm. Of these, C₆₀, C₇₀, C₇₆, C₈₂, etc. are preferably employed.

These fullerenes can be synthesized by publicly known processes.

For example, a process for producing C₃₆ is disclosed in New Daiamond, Vol. 16, No. 2, 2000, pp. 30-31. As a process for producing C₆₀, C₇₀, C₇₆, C₇₈, C₈₂, C₈₄, C₉₀ and C₉₆, a production process using an arc discharge method is disclosed in J. Phy. Chem., 94, 8634 (1990), and a production process using an oven/laser method is disclosed in Z. Phys. D, 40, 414 (1997). The higher fullerene wherein the number of carbon atoms in one molecule exceeds 96 and the maximum aggregate diameter is not more than 30 nm can be obtained as a by-product in the arc discharge method.

Examples of commercial products of these fullerenes include, as C₆₀ and C₇₀, products available from Frontier Carbon Corporation and products available from MATERIALS TECHNOLOGIES RESEARCH MTR LIMITED, and as C₇₆, C₇₈ and C₈₄, products available from MATERIALS TECHNOLOGIES RESEARCH MTR LIMITED.

The objects of the present invention can be attained also by mixtures of the above fullerenes having carbon atoms of different numbers. An example of a commercial product of such a mixture is a C₆₀/C₇₀ mixture available from Frontier Carbon Corporation, Honjo Chemical Corporation or MATERIALS TECHNOLOGIES RESEARCH MTR LIMITED.

The fullerene may be fullerene having on its surface a functional group, such as an alkyl group of 1 to 6 carbon atoms, an alkenyl group of 2 to 6 carbon atoms, an alkynyl group of 2 to 6 carbon atoms, a carboxyl group, a hydroxyl group, an epoxy group or an amino group. The amino group is represented by —NR₂¹, and in this formula, each R¹ can be independently a hydrogen atom, an alkyl group of 1 to 6 carbon atoms, an alkenyl group or 2 to 6 carbon atoms, an alkynyl group of 2 to 6 carbon atoms or a polyether chain having a molecular weight of 30 to 50,000. When the substituent R¹ in the amino group is a polyether chain, the end of the chain can be an alkoxyl group of 1 to 6 carbon atoms.

The fullerene derivative can be synthesized by, for example, epoxidation reaction disclosed in Science, 252, 548 (1991) and J. Am. Chem. Soc., 114, 1103 (1992), addition reaction of primary or secondary amine disclosed in Angew. Chem. Int. Ed. Engl., 30, 1309 (1991), Diels-Alder reaction disclosed in J. Am. Chem. Soc., 114, 7301 (1992) or poly-hydroxidation reaction disclosed in J. Chem. Soc., Chem. Commun., 1791 (1992).

As the derivative of a carbon cluster, any of chemically modified carbon clusters having photosensitizing function can be employed in the present invention, and chemically modified fullerene (fullerene derivative) is preferably employed.

In the present invention, a derivative of a carbon cluster having a heterocyclic ring may be used as the derivative of a carbon cluster. The derivative of a carbon cluster having a heterocyclic ring is, for example, a carbon cluster derivative wherein a group having a heterocyclic ring is bonded to a carbon cluster, and is preferably a carbon cluster derivative wherein a group having a heterocyclic ring is bonded to fullerene. The group having a heterocyclic ring is preferably a group having a furan ring and/or a thiophene ring as the heterocyclic ring.

The derivative of a carbon cluster having a heterocyclic ring can be obtained by Diels-Alder reaction of a carbon cluster with a compound having a heterocyclic ring such as a furan ring. More specifically, a carbon cluster, such as fullerene, and a compound having a heterocyclic ring, such as furfuryl alcohol, furoyl chloride, carboxyl furan or furfurylamine, are stirred in a solvent in which both components are soluble, whereby the reaction can be promoted. In this case, the carbon cluster and the compound having a heterocyclic ring are used in such amounts that a molar ratio of the carbon cluster to the heterocyclic ring satisfies the condition of carbon cluster/heterocyclic ring<1, and the reaction is preferably carried out under the temperature conditions of 30 to 100° C.

The derivative of a carbon cluster having a heterocyclic ring may be used alone, or may be used in combination with other carbon clusters and/or carbon cluster derivatives. In the present invention, it is preferable to use the derivative of a carbon cluster having a heterocyclic ring as the derivative of a carbon cluster because this derivative has excellent compatibility with other carbon clusters and/or derivatives of carbon clusters and has excellent solubility and dispersibility in a solvent.

When the carbon cluster derivative having a heterocyclic ring is a compound having plural heterocyclic rings and capable of being crosslinked or polycondensed by irradiation with light, a photo-curing composition having particularly excellent sensitivity and capable of forming a pattern of excellent endurance can be obtained.

In the present invention, a derivative of a carbon cluster wherein a group having a siloxane bond is bonded to the carbon cluster may be used as the derivative of a carbon cluster.

In the present invention, it is preferable that the carbon cluster and/or its derivative (A) contains fullerene and/or its derivative; it is more preferable that the carbon cluster and/or its derivative (A) contains fullerene C₆₀ and/or fullerene C₇₀ or their derivatives; and it is still more preferable that the carbon cluster and/or its derivative (A) contains fullerene C₆₀ and/or fullerene C₇₀.

In the present invention, it is also preferable that the carbon cluster and/or its derivative (A) contains fullerene wherein the total amount of fullerene C₆₀ and fullerene C₇₀ is in the range of 50 to 90% by weight, and there can be employed crude fullerene wherein the total amount of fullerene C₆₀ and fullerene C₇₀ is in the range of 50 to 90% by weight. When the carbon cluster and/or its derivative (A) containing such crude fullerene is used, a photo-curing composition of the present invention having satisfactory photosensitizing function can be obtained at a lower cost as compared with the case of using refined fullerene having high purity.

When the carbon cluster and/or its derivative (A) for use in the present invention contains fullerene C₆₀ and/or fullerene C₇₀, the total amount of the fullerene C₆₀ and the fullerene C₇₀ is preferably not less than 50% by weight, more preferably 50 to 90% by weight, in the whole amount of the carbon cluster and/or its derivative (A). In 100 parts by weight of the carbon cluster and/or its derivative (A) for use in the present invention, the total amount of fullerene and a fullerene derivative is preferably in the range of 50 to 100 parts by weight.

The carbon cluster and/or its derivative is preferably present almost homogeneously in the photo-curing composition of the present invention, and this component may be used by dissolving it in an organic solvent capable of dissolving it or may be used by dispersing it in the composition without dissolving it in a solvent.

When the carbon cluster and/or its derivative is used by dispersing it, it can be dispersed by, for example, placing a dispersing agent obtained by partially neutralizing an amino group-containing polymer such as polyethyleneimine or polyallylamine, an organic solvent and the carbon cluster and/or its derivative in a container and mechanically mixing them through ultrasonic dispersing, bead mill dispersing or the like. More specifically, there can be mentioned a method comprising mixing the carbon cluster and/or its derivative (A) with 1 to 10% (based on the component (A)) of a dispersing agent, such as Avicia Solsperse series (e.g., Solsperse 24000), Ajinomoto PB series, PLENACT series of Ajinomoto organic titanate coupling agent, Kyoueisha Chemical Froren G820, Bernd Schwegmann Schwego Wett 8037, Bernd Schwegmann Schwego Flour 8035, 8036, or Kusomoto Chemicals Disperon DA325, DA375, and 20 to 80% (based on the component (A)) of an organic solvent and then treating the mixture with an ultrasonic homogenizer for 10 to 60 minutes, or a method comprising adding 100 to 1000 parts by weight of titania beads of 0.1 to 1 mm to 100 parts by weight of a mixture of the carbon cluster and/or its derivative (A), a dispersing agent and an organic solvent and then treating the mixture with a bead mill disperser.

The amount of the carbon cluster and/or its derivative (A) in the photo-curing composition is in the range of preferably 0.01 to 5 parts by weight, more preferably 0.05 to 2 parts by weight, in 100 parts by weight of the composition except a solvent. If the amount thereof is less than 0.01 part by weight, the composition has poor photo-curing properties and a cured film is not obtained occasionally. If the amount exceeds 5 parts by weight, the carbon cluster is not dissolved or dispersed in a solvent sufficiently and a problem of precipitation sometimes occurs in the formation of a coating film.

### (B) Compound Having Heterocyclic Rings

The compound (B) having plural heterocyclic rings in a molecule for use in the present invention is a compound which can undergo crosslinking or polycondensation by a mechanism that the heterocyclic rings become reaction sites by the photosensitizing action of the carbon cluster and/or its derivative (A) upon irradiation with light, and the compound (B) has two or more heterocyclic rings in a molecule. Examples of the heterocyclic rings include a furan ring, a thiophene ring and a pyrrole ring. As the compound (B) for use in the present invention, a compound having plural furan rings or thiophene rings in a molecule is preferable, and a compound having plural furan rings are more preferable.

The compound (B) having plural heterocyclic rings in a molecule for use in the present invention may be a low-molecular compound or a high-molecular compound, or may be a mixture thereof. As the low-molecular compound, a compound having a molecular weight of not more than 1000 is preferably employed, and as the high-molecular compound, a compound having an average molecular weight of not less than 2000 is preferably employed.

When only a low-molecular compound having a molecular weight of not more than 1000 is used as the compound (B) having plural heterocyclic rings in a molecule, the amount of the compound (B) in 100 parts by weight of the photo-curing composition except a solvent is preferably not more than 50 parts by weight, because it is easy to allow the photo-curing composition to have a viscosity suitable for the film formation. The amount thereof is more preferably 10 to 50 parts by weight, particularly preferably 20 to 40 parts by weight. If the amount exceeds 50 parts by weight, unevenness of coating sometimes takes place in the film formation, or development after light exposure is sometimes made so ununiformly that it becomes difficult to obtain a desired shape.

When a compound having an average molecular weight of not less than 2000 is used as the compound (B) having plural heterocyclic rings in a molecule, this compound is, for example, a compound wherein heterocyclic rings are introduced into a side chain of a polymer, such as an acrylic-based polymer, an epoxy-based polymer or a polyimide-based polymer, or a polymer obtained by copolymerizing monomers containing heterocyclic rings. As such a compound (B), a compound having a hetrocylic ring at the end of the main chain of a polymer is also preferable. The compound (B) preferably contains a heterocyclic ring-containing polyimide resin, and the heterocyclic ring-containing polyimide resin is desired to be one wherein at least two heterocyclic ring units are introduced into the polyimide resin side chain.

The compound (B) having heterocyclic rings is desired to be soluble or highly dispersible in a solvent. When the compound (B) having heterocyclic rings contains a heterocyclic ring-containing polyimide resin, the hetrocyclic ring-containing polyimide resin is preferably soluble in a solvent and is more preferably a soluble polyimide resin having excellent transparency from the viewpoint of enhancement of photo-curing properties.

It is preferable that the compound (B) having plural heterocyclic rings in a molecule for use in the present invention has a heterocyclic ring at least one end in the direction of a major axis of a molecule.

In order to enhance photo-curing properties, it is also preferable that the compound (B) having plural heterocyclic rings in a molecule for use in the present invention has a siloxane bond in a molecule. When the compound (B) having plural heterocyclic rings in a molecule is a high-molecular compound, the compound may have a siloxane bond introduced into the main chain or may have a group having a siloxane bond in the side chain.

The compound (B) having plural heterocyclic rings in a molecule and containing a siloxane bond can be obtained by introducing heterocyclic rings into a side chain of a polymer having a siloxane bond or by allowing a polymer having heterocyclic rings to react with a siloxane macromer. Examples of the polymers having a siloxane bond include commercial resins, such as X-22-8917 (available from Shinetsu Chemical Industry Co., Ltd.) and Compoceran H901 (available from Arakawa Chemical Industries, Ltd.) as Si modified products of polyimide; X-22-8084 (available from Shinetsu Chemical Industry Co., Ltd.) as a Si modified product of acrylic resin; X-22-2760 (available from Shinetsu Chemical Industry Co., Ltd.) and Compoceran U301 (available from Arakawa Chemical Industries, Ltd.) as Si modified products of urethane resin; and Compoceran E102 (available from Arakawa Chemical Industries, Ltd.) as a Si modified product of epoxy resin. Further, the polymer having a siloxane bond can be prepared by copolymerizing a siloxane macromer such as F₃-009-01 (available from Nippon Unicar Co., Ltd.) or a siloxane-containing monomer such as A-174 (available from Nippon Unicar Co., Ltd.) in the synthesis of an acrylic resin.

Next, the compound (B) having plural heterocyclic rings in a molecule for use in the present invention is described more specifically with reference to a compound having furan rings as the heterocyclic rings, and the same shall apply to a compound having thiophene rings as the heterocyclic rings.

As a low-molecular compound having plural furan rings in a molecule, a compound having a molecular weight of preferably not more than 1000, more preferably 200 to 1000, is desirable, and examples of such compounds include compounds, such as furoin, furil, furfuryl sulfide, a compound represented by the following formula (1) that is synthesized from p-aminobenzyl alcohol and 2-furoyl chloride, a compound represented by the following formula (2) that is obtained by addition reaction of a polyfunctional epoxy compound with 2-carboxylfuran, and a compound obtained by allowing tetracarboxylic anhydride to react with furfurylamine.

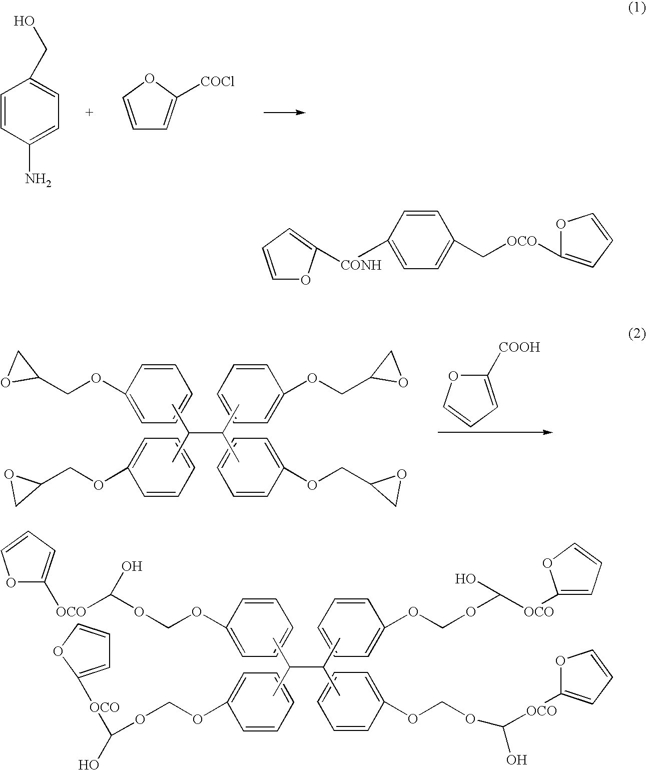

As a high-molecular compound having plural furan rings in a molecule, a compound having an average molecular weight of not less than 1000, preferably not less than 2000, more preferably 2000 to 100,000, is desirable, and examples of such compounds include a furan resin that is a condensate of furfural or furfuryl alcohol and/or a phenolic resin, a compound obtained by introducing furan rings into an acrylic-based polymer, an epoxy-based polymer or a polyimide-based polymer, and a polymer obtained by copolymerizing monomers having furan rings (e.g., a furan resin that is a condensate of furfural or furfuryl alcohol and/or a phenolic resin).

More specifically, there can be mentioned a high-molecular compound represented by the following formula (3) that is obtained by allowing an acrylic-based polymer to react with a compound having furan rings such as furoyl chloride, a high-molecular compound represented by the following formula (4) that is obtained by allowing an epoxy-based polymer to react with a compound having furan rings such as carboxyl furan, and a high-molecular compound represented by the following formula (5) or (6) that is obtained by allowing a polyimide-based polymer to react with a compound having furan rings such as furfuryl alcohol or furfurylamine.

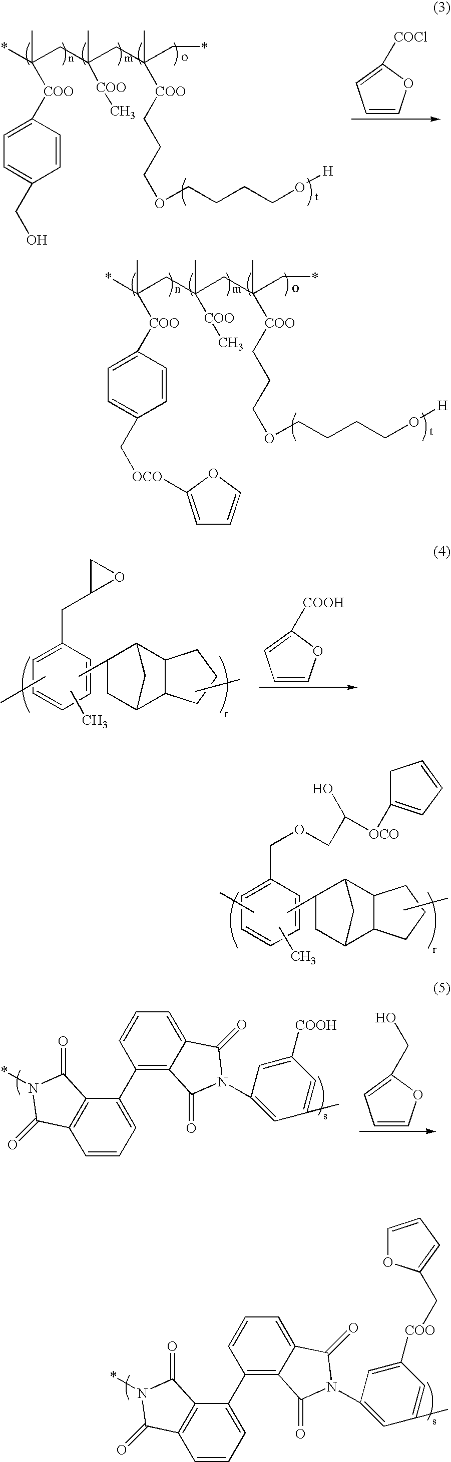

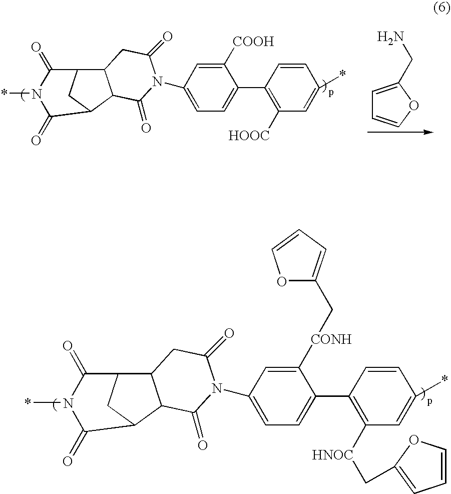

In the above formulas, m to s are each a positive integer, and t is an integer of 1 to 10.

The acrylic-based polymer employable in the preparation of such a high-molecular compound as represented by the formula (3) that is derived from an acrylic-based polymer is obtained by (co)polymerizing a (meth)acrylic monomer having a functional group which becomes a site to introduce a furan ring, and if necessary, a monomer which is employable in combination with the (meth)acrylic monomer.

Examples of the (meth)acrylic monomers include carboxyl group-containing monomers, such as acrylic acid, methacrylic acid, maleic acid, fumaric acid, crotonic acid, itaconic acid, citraconic acid, mesaconic acid, cinnamic acid, mono-2-methacryloyloxyethyl hexahydrophthalate and mono-2-methacryloyloxyethyl succinate; hydroxyl group-containing monomers, such as 2-hydroxyethyl (meth)acrylate, 2-hydroxypropyl (meth)acrylate and 3-hydroxypropyl (meth)acrylate; and phenolic hydroxyl group-containing monomers, such as methacryloyloxybenzyl alcohol, o-hydroxystyrene, m-hydroxystyrene and p-hydroxystyrene. At least one monomer selected from these monomers can be employed.

Examples of the monomers employable in combination with the above (meth)acrylic monomers include (meth)acrylic acid esters, such as 2-benzyl-2-propyl acrylate, methyl (meth)acrylate, ethyl (meth)acrylate, butyl (meth)acrylate, benzyl (meth)acrylate, glycidyl (meth)acrylate and dicyclopentanyl (meth)acrylate; aromatic vinyl monomers, such as styrene and α-methylstyrene; conjugated dienes, such as butadiene and isoprene; (meth)acrylic acid esters containing propylene glycol chain, butylene glycol chain or ethylene glycol chain in the side chain, such as methoxypolyethylene glycol (meth)acrylate, methoxypolypropylene glycol (meth)acrylate, methoxypolybutylene glycol (meth)acrylate, propylene glycol polybutylene glycol (meth)acrylate and ethylene glycol polypropylene glycol (meth)acrylate; and methacryloyloxyethyl isocyanate (MOI). At least one monomer selected from these monomers can be employed.

The acrylic-based polymer can be synthesized by copolymerization reaction of the above monomers. As the copolymerization reaction, radical polymerization is suitable, and for example, emulsion polymerization, suspension polymerization, solution polymerization or bulk polymerization is employable. Of these, solution polymerization is preferable, and a solvent used for the solution polymerization is not specifically restricted provided that it is unreactive to the monomers and dissolves the resulting acrylic-based polymer. Examples of such solvents include methanol, ethanol, n-hexane, toluene, tetrahydrofuran, 1,4-dioxane, ethyl acetate, butyl acetate, acetone, methyl ethyl ketone, methyl isobutyl ketone, 2-heptanone, ethylene glycol monomethyl ether, propylene glycol monomethyl ether, propylene glycol monomethyl ether acetate, methyl 3-methoxypropionate, ethyl 3-ethoxypropionate, ethyl lactate and γ-butyrolactone.

As the epoxy-based polymer employable in the preparation of such a high-molecular compound as represented by the formula (4) that is derived from an epoxy-based polymer, any of high-molecular compounds having plural epoxy groups that become sites to introduce furan rings can be employed. Examples of such compounds include the above-exemplified polymers, solid epoxy compounds based on novolak resins, such as Epicoat 154, Epicoat 157S65 and Epicoat 1032 (available from Yuka-Shell Epoxy Co., ltd.) and VG3101 (available from Mitsui Chemicals, Inc.), and alicyclic epoxy resins, such as Epolead GT401 (available from Dicel Chemical Industries, Ltd.).

The compound (B) having heterocyclic rings in a molecule is also preferably such a heterocyclic ring-containing polyimide resin as represented by the aforesaid formula (5) or (6). The photo-curing composition of the present invention containing a heterocyclic ring-containing polyimide resin as the compound (B) can be favorably used not only as a photoresist composition but also for producing medical instruments.

The polyimide-based polymer employable in the preparation of such a high-molecular compound as represented by the formula (5) or (6) that is derived from a polyimide-based polymer is a solvent-soluble polyimide-based polymer synthesized from an acid anhydride and diamine. In the preparation of the polyimide-based polymer, the acid anhydride and diamine are used in such amounts that the proportion of an acid anhydride group of the acid anhydride to 1 equivalent of an amino group of diamine becomes preferably 0.2 to 2 equivalents, more preferably 0.3 to 1.2 equivalents.

The solvent-soluble polyimide-based polymer can be obtained by subjecting an acid anhydride and diamine to polycondensation reaction in a non-proton type polar solvent under the temperature conditions of usually −20° C. to 150° C., preferably 0 to 100° C., to form polyamic acid and then subjecting the polyamic acid to chemical imidation with pyridine and acetic anhydride.

It is also possible to introduce a furan ring at the polyimide end by making the ratio of the acid anhydride to diamine higher than 1 to thereby allow the polymer end to have an acid anhydride structure and reacting the polymer end with furfurylamine.

Examples of the acid anhydrides include 1,3,3a,4,5,9b-hexahydro-5-(tetrahydro-2,5-dioxo-3-furanyl)-naphtho[1,2-c]furan-1,3-dione, cis-3,7-dibutylcycloocta-1,5-diene-1,2,5,6-tetracarboxylic dianhydride, 3,5,6-tricarbonyl-2-carboxynorbornane-2:3,5:6-dianhydride, 1,3,3a,4,5,9b-hexahydro-8-methyl-5-(tetrahydro-2,5-dioxo-3-furanyl)-naphtho[1,2-c]furan-1,3-dione, 3-oxabicyclo[3,2,1]octane-2,4-dione-6-spiro-3′-(tetrahydrofuran-2′,5′-dione), 4,10-dioxatricyclo[6.3.1.0^{2,7}]dodecane-3,5,9,11-tetraone and butanetetracarboxylic dianhydride.

As the diamine, a diamine compound containing a furan ring in a molecule (e.g., the following compounds 1-(1) to 1-(6) described in Japanese Patent Laid-Open Publication No. 302598/2001) or diamine having a site (functional group) to introduce a furan ring is preferably employed, and examples of such diamines include 3,5-diaminobenzoic acid and diamine compounds represented by the following formulas (7), (8) and (9).

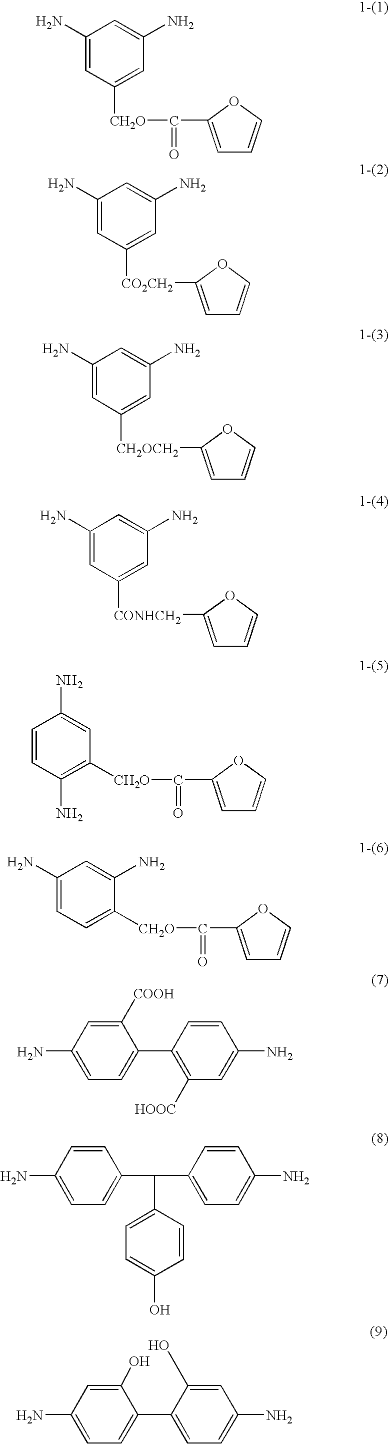

With the diamine having a site (functional group) to introduce a furan ring, other diamines can be used in combination. Examples of other diamines employable in combination include aromatic diamines, such as p-phenylenediamine, 4,4′-diaminodiphenylmethane, 4,4′-diaminodiphenyl sulfide, 2,7-diaminofluorene, 4,4′-diaminodiphenyl ether, 2,2-bis[4-(4-aminophenoxy)phenyl]propane, 9,9-bis(4-aminophenyl)fluorene, 2,2-bis[4-(4-aminophenoxy)phenyl]hexafluoropropane and 2,2-bis(4-aminophenyl)hexafluoropropane; aliphatic diamines, such as 1,1-metaxylylenediamine, 1,4-diaminocyclohexane, isophoronediamine, tetrahydrodicyclopentadienylenediamine, hexahydro-4,7-methanoindanylenedimethylenediamine, tricyclo[6.2.1.0^{2,7}]undecylenedimethyldiamine and 4,4′-methylenebis(cyclohexylamine); and diaminoorganosiloxane represented by the following formula (10).

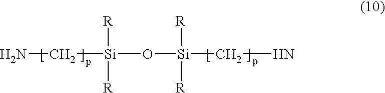

In the formula (10), each R is independently a hydrocarbon group of 1 to 12 carbon atoms, p is an integer of 1 to 3, and q is an integer of 1 to 20.

In the photo-curing composition of the present invention, the compound (B) having plural heterocyclic rings in a molecule is desirably used in such an amount that the proportion of the heterocyclic rings contained is in the range of 1 to 100,000 times, preferably 50 to 20,000 times, the molar quantity of the carbon cluster and/or its derivative (A) having a photosensitizing function.

In the photo-curing composition of the present invention, the compound (B) having plural heterocyclic rings in a molecule is desirably contained in an amount of not less than 5 parts by weight, preferably not less than 10 parts by weight, more preferably not less than 15 parts by weight, in 100 parts by weight of the photo-curing composition except a solvent. If the content of the compound (B) is less than 5 parts by weight, photo-curing of a coating film becomes insufficient, and patterning into a desired shape sometimes becomes difficult. The content of the compound (B) has influence on a crosslink density of a photo-cured product, and with increase of the content, the crosslink density becomes higher, and a cured product of higher strength and lower elasticity (rigid and fragile) is obtained. By appropriately controlling the content of the compound (B), property values of a cured film can be controlled.

### (C) Photo-Insensitive Resin

For the purpose of obtaining a desired viscosity or controlling film properties of a coating film, the photo-curing composition of the present invention can contain a photo-insensitive resin, namely, a resin which undergoes no oxidation polycondensation reaction, when needed. Examples of the photo-insensitive resins employable in the present invention include acrylic-based polymers, epoxy-based polymers such as solid epoxy resin, polyimide-based polymers such as soluble polyimide, and polymers containing a siloxane bond, which are used for preparing the aforesaid high-molecular compounds having heterocyclic rings; and other resins, such as polybenzoxazole, polybenzimidazole, silicone rubber particles and crosslinked SBR or NBR particles. Of these, a resin having been improved in transparency in the visible region by nucleus-hydrogenating aromatic ring, or a resin using an aliphatic compound as a constituent is preferably employed.

The photo-insensitive resin (C) for use in the present invention is preferably a heat-resistant resin, and preferably contains a siloxane bond in a molecule. When the photo-insensitive resin (C) contains a siloxane bond in a molecule, this resin may contain a siloxane bond in the main chain or may contain a group having a siloxane bond in the side chain.

The photo-insensitive resin (C) is desirably used in an amount of 0 to 1000 parts by weight based on 100 parts by weight of the heterocyclic ring-containing compound.

If the compound (B) having heterocyclic rings in a molecule is not a heterocyclic ring-containing polyimide resin, it is also preferable that a polyimide resin is contained as the photo-insensitive resin (C) in the photo-curing composition of the present invention. As the polyimide resin desirable as the photo-insensitive resin (C), soluble polyimide that is soluble in a solvent is preferable, and a soluble polyimide resin having excellent transparency is more preferable from the viewpoint of enhancement of photo-curing properties. Such a polyimide resin can be used in an amount of not less than 50 parts by weight, preferably not less than 60 parts by weight, more preferably not less than 80 parts by weight, in 100 parts by weight of the photo-curing composition of the present invention except a solvent, from the viewpoint of biocompatibility in case of medical instrument applications. In the production of a medical instrument using the photo-curing composition of the present invention containing polyimide as the component (C), if the amount of the polyimide is less than 50 parts by weight, biocompatibility sometimes becomes insufficient, or the resulting coating layer sometimes has insufficient film strength and exhibits poor endurance.

The solvent-soluble polyimide resin that is preferably used as the component (C) can be synthesized from an acid anhydride and diamine. In the preparation of the polyimide resin, the acid anhydride and diamine are used in such amounts that the proportion of an acid anhydride group of the acid anhydride to 1 equivalent of an amino group of diamine becomes preferably 0.2 to 2 equivalents, more preferably 0.3 to 1.2 equivalents.

The solvent-soluble polyimide resin can be obtained by subjecting an acid anhydride and diamine to polycondensation reaction in a non-proton type polar solvent under the temperature conditions of usually −20° C. to 150° C., preferably 0 to 100° C., to form polyamic acid and then subjecting the polyamic acid to chemical imidation with pyridine and acetic anhydride.

Examples of the acid anhydrides include 1,3,3a,4,5,9b-hexahydro-5-(tetrahydro-2,5-dioxo-3-furanyl)-naphtho[1,2-c]furan-1,3-dione, cis-3,7-dibutylcycloocta-1,5-diene-1,2,5,6-tetracarboxylic dianhydride, 3,5,6-tricarbonyl-2-carboxynorbornane-2:3,5:6-dianhydride, 1,3,3a,4,5,9b-hexahydro-8-methyl-5-(tetrahydro-2,5-dioxo-3-furanyl)-naphtho[1,2-c]furan-1,3-dione, 3-oxabicyclo[3,2,1]octane-2,4-dione-6-spiro-3′-(tetrahydrofuran-2′,5′-dione) and 4,10-dioxatricyclo[6.3.1.0^{2,7}]dodecane-3,5,9,11-tetraone. By the use of such an acid anhydride, soluble polyimide having excellent transparency and solubility is obtained.

Examples of the diamines include aromatic diamines, such as p-phenylenediamine, 4,4′-diaminodiphenylmethane, 4,4′-diaminodiphenyl sulfide, 2,7-diaminofluorene, 4,4′-diaminodiphenyl ether, 2,2-bis[4-(4-aminophenoxy)phenyl]propane, 9,9-bis(4-aminophenyl)fluorene, 2,2-bis[4-(4-aminophenoxy)phenyl]hexafluoropropane and 2,2-bis(4-aminophenyl)hexafluoropropane; aliphatic diamines, such as 1,1-metaxylylenediamine, 1,4-diaminocyclohexane, isophoronediamine, tetrahydrodicyclopentadienylenediamine, hexahydro-4,7-methanoindanylenedimethylenediamine, tricyclo[6.2.1.0^{2,7}]undecylenedimethyldiamine and 4,4′-methylenebis(cyclohexylamine); and diaminoorganosiloxane represented by the following formula.

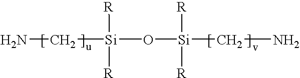

In the above formula, each R is independently a hydrocarbon group of 1 to 12 carbon atoms, u is an integer of 1 to 3, and v is an integer of 1 to 20.

### Compound Having Siloxane Bond

The photo-curing composition of the present invention preferably contains a compound having a siloxane bond in a molecule. The compound having a siloxane bond in a molecule is effective for promoting dissolution of oxygen in a coating film or diffusion of excited oxygen in a coating film, and is desirably in a homogeneously compatible or dispersed state in the photo-curing composition or a coating film formed from the composition.

Although the compound having a siloxane bond in a molecule is desirably contained in any one of the carbon cluster or its derivative (A), the compound (B) having plural heterocyclic rings in a molecule and the photo-insensitive resin (C), it may be contained independently from the components (A), (B) and (C). It is preferable that the compound having a siloxane bond in a molecule is contained in at least one of the components (A), (B) and (C) because the siloxane bonds are likely to be in a homogeneously compatible or dispersed state in the photo-curing composition of the present invention.

### Solvent

The photo-curing composition of the present invention can contain an organic solvent that is properly selected according to the selection of the components. Although the solvent for use in the present invention is preferably one in which each component of the photo-curing composition is soluble, it may be one in which each component is homogeneously dispersible. Examples of the solvents include methyl ethyl ketone, methyl isobutyl ketone, 2-heptanone, cyclohexanone, ethylene glycol monomethyl ether, propylene glycol monomethyl ether, propylene glycol monomethyl ether acetate, methyl 3-methoxypropionate, ethyl 3-ethoxypropionate, ethyl lactate, benzaldehyde, furfuryl alcohol, furfural, benzonitrile and γ-butyrolactone. At least one solvent selected from these solvents can be employed.

Of the above-solvents, ethylene glycol monomethyl ether, propylene glycol monomethyl ether, propylene glycol monomethyl ether acetate, methyl 3-methoxypropionate, cyclohexanone, ethyl 3-ethoxypropionate, ethyl lactate, benzaldehyde, furfuryl alcohol, furfural and γ-butyrolactone are preferably used from the viewpoints of uniformity of a coating film and safety.

The solvent can be used in such an amount that desired viscosity and concentration are obtained, and for example, the solids concentration of the photo-curing composition can be made in the range of usually 5 to 60% by weight, preferably 10 to 50% by weight.

### Photopolymerization Initiator

In order to control photosensitive properties, the photo-curing composition of the present invention may contain a small amount of a photo radical polymerization initiator, a photo cationic polymerization initiator or the like, in addition to the carbon cluster and/or its derivative (A) having a photosensitizing function.

Examples of the photo radical polymerization initiators include α-diketones, such as benzyl and diacetyl; acyloins, such as benzoin; acyloin ethers, such as benzoin methyl ether, benzoin ethyl ether and benzoin isopropyl ether; benzophenones, such as thioxanthone, 2,4-diethylthioxanthone, thioxanthone-4-sulfonic acid, benzophenone, 4,4-bis(dimethylamino)benzophenone and 4,4′-bis(diethylamino)benzophenone; acetophenones, such as acetophenone, p-dimethylaminoacetophenone, α,α′-dimethoxyacetoxybenzophenone, 2,2′-dimethoxy-2-phenylacetophenone, p-methoxyacetophenone, 2-methyl[4-(methylthio)phenyl]-2-morpholino-1-propanone and 2-benzyl-2-dimethylamino-1-(4-morpholinophenyl)-butane-1-one; quinones, such as anthraquinone and 1,4-naphthoquinone; halogen compounds, such as phenacyl chloride, tribromomethylphenylsulfone and tris(trichloromethyl)-s-triazine; peroxides, such as di-t-butyl peroxide; and acylphosphine oxides, such as 2,4,6-trimethylbenzoyldiphenylphosphine oxide. Examples of commercial products of the photo radical polymerization initiators include Irgacure 184, 651, 500, 907, CG1369, CG24-61, Dalocure 1116, 1173 (available from Ciba Specialty Chemicals Inc.), Lucirin LR8728, TPO (available from BASF Corporation), and Ubecryl P36 (available from UCB Co.).

As the photo cationic polymerization initiator, a publicly known photo cationic polymerization initiator is employable. For example, commercial products, such as Adeca Ultra Set PP-33 (available from Asahi Denka Co., Ltd.) that is a diazonium salt, Optomer SP-150, 170 (available from Asahi Denka Co., Ltd.) that is a sulfonium salt and Irgacure 261 (available from Ciba Specialty Chemicals Inc.) that is a metallocene compound, are employable.

In the present invention, such a photopolymerization initiator as mentioned above can be used by adding it to the aforesaid component (A), (B) or (C), but in the case where a medical instrument is produced by the use of the photo-curing composition of the present invention, it is preferable to use no other photopolymerization initiator than the carbon cluster and/or its derivative (A), from the viewpoint of influence on the organism.

### Other Components

The photo-curing composition of the present invention can contain other components in addition to the above-mentioned components, when needed, so long as the effects of the present invention are not impaired. Examples of such components include those employable as additives for conventional negative photoresist compositions.

In the case where a medical instrument is produced by the use of the photo-curing composition of the present invention, it is preferable that components of low-molecular weight are not contained as the other components in the photo-curing composition, from the viewpoint of influence on the organism.

### Photo-Curing Composition

The photo-curing composition of the present invention is a composition consisting of the components described above and has properties of being cured by 5 crosslinking or polycondensation of the components upon irradiation with light. The photo-curing composition of the present invention is usually used after a solvent is added to the composition to adjust its viscosity to that suitable for coating. Using such a composition, a coating film is formed, then the solvent is removed, and thereafter the film is irradiated with light, whereby the film can be cured.

The photo-curing composition of the present invention can be obtained by mixing the above components by a known method. For example, a solution A wherein the carbon cluster and/or its derivative (A) is dissolved in a high concentration in a solvent that has a highest dissolving power and a solution B wherein other components are dissolved in a solvent that is capable of dissolving the resin component are prepared, and the solution A is slowly added to the solution B to obtain the photo-curing composition.

Because the photo-curing composition of the present invention contains as its component the carbon cluster and/or its derivative (A) having a photosensitizing function, the component (A) excites oxygen upon irradiation with light, and the excited oxygen accelerates polycondensation of the heterocyclic rings of the compound (B) having plural heterocyclic rings in a molecule. Accordingly, even in the case where no other photopolymerization initiator is used, the photo-curing composition of the present invention exhibits excellent sensitivity properties in a wide wavelength region including visible light or ultraviolet light, and especially when the composition contains a compound having a siloxane bond, mobility of the excited oxygen that becomes a crosslinking reaction medium is increased, and hence, the composition exhibits more excellent sensitivity properties.

Further, because the photo-curing composition of the present invention contains the carbon cluster and/or its derivative (A), endurance of a pattern formed from the composition is improved, and a cured film having excellent insulating properties and heat resistance can be formed. Moreover, a cured product formed from the photo-curing composition of the present invention is excellent in heat resistance, insulating properties and chemical resistance.

Such a photo-curing composition of the present invention can be favorably used as a negative photoresist composition capable of forming a fine pattern, and a photosensitive insulating film used for the manufacture of semiconductor devices, liquid crystal devices, etc. or used in the field of mounting such devices can be produced with low heat history and low light irradiation history.

By the use of the photo-curing composition of the present invention, a coating film can be formed also on a material of a fine shape, and a cured product formed from the photo-curing composition of the present invention can be favorably used as a material for forming films on various materials because the cured product has excellent heat resistance, insulating properties and chemical resistance. The material on which a film of the composition is formed may be any of an inorganic material such as glass or metal and an organic material such as plastic, and the composition of the present invention can be used as a coating material for medicine containers and the like.

When the photo-curing composition of the present invention is used as a negative photoresist composition, pattern formation can be carried out by, for example, the following process.

### Process for Pattern Formation

The photo-curing composition of the present invention having been adjusted to have desired viscosity and concentration is applied on a substrate, dried to remove a solvent, then exposed to light and developed, whereby a fine pattern can be obtained.

Application of the composition can be carried out by a usual film-forming method, and for example, screen printing, roll coating, rotary coating or cast coating is available.

The substrate to be coated is not specifically restricted provided that a coating film can be formed thereon, and examples of such substrates include films or substrates of polyester, polycarbonate, aromatic amide, polyamidoimide, polyimide, glass and silicon. Of these, preferable are a polyester film, such as a polyethylene terephthalate film, and a silicon substrate.

The drying temperature of the coating film is a temperature at which a solvent in the film can be removed to such a degree that the subsequent steps are not influenced, and for example, the temperature is in the range of about 60 to 130° C. The film thickness is usually in the range of 0.5 to 50 μm.

In the next step, the film is irradiated with a radiation such as visible light or ultraviolet light in a desired shape and then developed to form a pattern. In more detail, the film is irradiated with a radiation in a desired shape to perform light exposure, whereby the exposed portion is crosslinked and thereby insolubilized, and then, using a developing solution, the unexposed portion is dissolved and removed to form a pattern. Examples of the radiations used herein include low-pressure mercury lamp, high-pressure mercury lamp, ultra-high-pressure mercury lamp, metal halide lamp, ultraviolet radiation such as g line or i line stepper, electron radiation and laser beam. When the radiation is ultraviolet radiation, irradiation is usually carried out through a mask pattern, but when the radiation is electron radiation or laser beam, irradiation is preferably directly carried out in a desired shape without a mask. As the developing solution, an alkali developing solution, an organic solvent developing solution or an aqueous developing solution is employable.

In the photo-curing composition of the present invention, it is preferable that the compound (B) having heterocyclic rings in a molecule contains a heterocyclic ring-containing polyimide resin, and it is also preferable that the photo-insensitive resin (C) contains a polyimide resin. Also in the case where the photo-curing composition of the present invention is such a photo-curing polyimide resin composition, the composition exhibits excellent sensitivity properties in a wide wavelength region including visible light or ultraviolet light even if no other photopolymerization initiator than the carbon cluster and/or its derivative (A) is used, as previously described. Especially when the composition contains a compound having a siloxane bond, mobility of the excited oxygen that becomes a crosslinking reaction medium is increased, and hence, the composition exhibits more excellent sensitivity properties.

Further, because the photo-curing composition of the present invention that is the photo-curing polyimide resin composition contains the carbon cluster and/or its derivative (A), endurance of a pattern formed from the composition is improved, and a cured film having excellent insulating properties and heat resistance can be formed. Moreover, a cured product formed from the photo-curing polyimide resin composition of the present invention is excellent in heat resistance, insulating properties and chemical resistance.

By the use of the photo-curing composition of the present invention that is the photo-curing polyimide resin composition, a coating film can be formed also on a material of a fine shape, and instead of conventional polyimide of heat baking type or vapor evaporation polymerization type, a polyimide thin film can be readily formed highly accurately. A cured product formed from the photo-curing composition of the present invention that is the photo-curing polyimide resin composition can be favorably used as a material for forming films on various materials because the cured product has excellent heat resistance, insulating properties and chemical resistance. The material on which a film of the composition is formed may be any of an inorganic material such as glass or metal and an organic material such as plastic, and the composition of the present invention can be used as a coating material for medicine containers and the like.

For forming a thin film from the photo-curing composition of the present invention, the photo-curing composition is usually applied on a substrate, dried and then irradiated with light, whereby the substrate surface can be readily coated with a cured film, and the film formation can be carried out at a low temperature for a short period of time. Because the photo-curing composition is a photo-curing resist, a pattern of a cured film having a desired shape can be formed on a substrate by performing irradiation with light through an arbitrary mask pattern, and for example, in the production of a medical instrument, it becomes possible to further improve biocompatibility easily by properly selecting the shape.

As a process for forming a cured film from the photo-curing composition of the present invention, a process comprising applying the photo-curing polyimide resin composition on a substrate, drying the composition to remove the solvent and then irradiating it with light to cure the resin is available. By controlling the irradiation light and by washing the unexposed portion, a pattern of a cured film can be obtained.

The substrate to be coated is not specifically restricted provided that a coating film can be formed thereon, and examples of such substrates include films or substrates of polyester, polycarbonate, aromatic amide, polyamidoimide, polyimide, glass, silicon, ceramic and SUS.

When the substrate is in the form of a sheet, coating can be carried out by screen printing, roll coating, rotary coating, cast coating or the like, and when the substrate is in the form of a bar such as a mandrel, coating can be carried out by dip coating, spray coating or the like.

Drying after coating is carried out at a temperature such that the solvent in the composition is removed to a certain degree and the coating film does not flow, and the temperature is usually about 60 to 130° C.

The film thickness obtained by one coating is usually in the range of 1 to 100 μm.

There is no specific limitation on the pattern, material, etc. of a photo mask. The type (wavelength, intensity) of light and the irradiation time necessary for curing are appropriately determined according to the formulation of the photo-curing resin composition, and for example, the composition can be irradiated with light having a wavelength region of 200 to 800 nm for a period of 1 second to 10 minutes. The composition can be favorably cured also by the use of only visible light having a wavelength region of 400 to 800 nm.

The irradiation dose is in the range of usually 100 to 3000 mJ, preferably 500 to 2000 mJ.

In the case where a cured film is formed from the photo-curing composition of the present invention, it is necessary from its photo-curing mechanism to supply oxygen to the coating film in the light exposure, and an exposure system wherein a photo mask is brought into contact with the coating film is undesirable.

In order to accelerate crosslinking reaction or remove the residual solvent, the coating film having been irradiated with light is baked at a temperature of 100 to 150° C., thereafter the film is subjected to development when needed, and then the film is dried at a temperature of 150 to 200° C. to remove the solvent and water from the film.

By repeating the above steps (coating-drying-light exposure-baking-development-drying), a cured thin film, such as a polyimdie thin film, having a thickness of 1 μm to 1000 μm, preferably 10 to 100 μm can be formed accurately, and further, by performing light exposure using a mask pattern, processing of the surface of the cured film such as a polyimdie thin film into a desired shape becomes possible.

It is known that when a medical instrument is produced using the photo-curing composition of the present invention that is a photo-curing polyimide resin composition, shape of a surface of a thin film formed on the surface of the medical instrument, said thin film surface being brought into contact with the organism, has great influence on the cell proliferation properties and the like. For example, the shape proposed in Japanese Patent Laid-Open Publication No. 149061/2001 can be readily attained by the present invention through the steps of mask exposure-development.

Further, it is also possible to adapt the optical stereo-molding process proposed in Japanese Patent Laid-Open Publication No. 247515/1985, U.S. Pat. No. 4,575,330 (Japanese Patent Laid-Open Publication No. 35966/1987), Japanese Patent Laid-Open Publication No. 101408/1987, Japanese Patent Laid-Open Publication No. 24119/1993, etc. to the photo-curing composition of the present invention such as a photo-curing polyimide resin composition, and thereby a polyimide structure of complicated shape can be readily embodied. A typical example of the optical stereo-molding process is described below. A photo-curing polyimide resin composition contained in a container is selectively irradiated on the liquid level with light such as ultraviolet laser beam to form a cured resin layer having a given pattern. Then, onto the cured resin layer, a photo-curing resin composition is fed in an amount corresponding to one layer, and the composition is selectively irradiated on the liquid level with light to form a new cured resin layer on the previously formed cured resin layer so that the new layer should be continuous from the previously formed layer. By repeating the above process given times with changing or without changing the pattern to be irradiated with light, a stereo-structure of a laminate integrally formed from plural cured resin layers is formed. This optical stereo-molding process has an advantage that a desired stereo-structure can be readily obtained for a short period of time even if the shape of the stereo-structure is complicated.

According to the present invention, a photo-curing composition which can be favorably used as a negative photoresist composition, can form a fine pattern because of high sensitivity properties and can produce a cured film having excellent heat resistance, chemical resistance and insulating properties can be provided. By the use of the photo-curing composition of the present invention, a photosensitive insulating film used for the manufacture of semiconductor devices, liquid crystal devices, etc. or used in the field of mounting such devices can be produced with low heat history and low light irradiation history.

According to the present invention, further, a polyimide resin film having a desired fine shape and a desired thickness can be favorably formed by the use of the photo-curing composition of the present invention that is a specific photo-curing polyimide resin composition, and the resulting polyimide film is excellent in dynamical properties, heat resistance and biocompatibility. Therefore, adaptation of the film to medical instruments becomes possible, and hence, an excellent process for producing medical instruments and excellent medical instruments can be provided.

That is to say, the mainstream of production of polyimide that is conventionally used for medical instruments is vapor evaporation polymerization or high-temperature baking of polyimide precursor, and control of shape or film thickness of the polyimide resin has been made almost manually, so that the industrial mass productivity of the polyimide is markedly poor. In contrast therewith, in the present invention, the above problems of processing and mass production can be solved at a stretch by the photo-curing system, and performance of medical instruments, such as medical image fibers, medical catheters, medical tubes and bags, can be remarkably enhanced.

### EXAMPLES

The present invention is further described with reference to the following examples, but it should be construed that the invention is in no way limited to those examples.

### Preparation Example 1

In 100 ml of toluene, 7 g of crude fullerene (available from Honjo Chemical Corporation, containing about 85% of fullerene C₆₀) was suspended and dissolved, and the resulting solution was irradiated with a flash discharge lamp (manufactured by USHIO INC.) at 10 pulses under the conditions of a current density of 2 kA/cm² and a pulse width of 0.3 ms to obtain carbon clusters (A).

The carbon clusters (A) were subjected mass spectrometry by TOF-MS. As a result, addition with 1 to 5 oxygen atoms on an average took place based on one molecule of C₆₀, so that the carbon clusters (A) were presumed to be mixtures of fullerenes epoxidation of which had proceeded, as described in J. Am. Chem. Soc., 114, 1103 (1992).

### Preparation Example 2

In a bead mill disperser, 10 g of crude fullerene (available from Frontier Carbon Corporation, containing about 60% of fullerene C₆₀), 0.5 g of Solsperse 20000 (available from Avicia), 40 g of propylene glycol monomethyl ether acetate and 50 g of titania beads of 0.5 mm diameter were dispersed and mixed.

The titania beads were removed by means of a wire mesh to obtain 45 g of carbon clusters (B) in the form of a fullerene dispersion (solids concentration: 16%). In the dispersion, precipitation was not observed at all, and the dispersion was stable even after it was allowed to stand for 1 month at 5° C.

### Preparation Example 3

In a light-blocking container, 5 g of a compound (b) synthesized in Preparation Example 6 described later, 0.1 g of crude fullerene (available from Frontier Carbon Corporation, containing about 60% of fullerene C₆₀) and 10 g of propylene glycol monomethyl ether acetate were placed, and they were mixed and reacted at 80° C. for 5 hours under ultrasonic irradiation.

Most of the crude fullerene was precipitated before the reaction, but after the reaction, precipitation was not observed at all, and the reaction solution was stable even after it was allowed to stand for 1 month at 5° C.

This solution (solids concentration: 33%) is referred to as “carbon clusters (C)”.

### Preparation Example 4

In a toluene solvent, 1 g of furancarboxylic acid and 100 g of crude fullerene (available from Frontier Carbon Corporation, containing about 60% of fullerene C₆₀) were heated under reflux for 3 hours, then toluene and the unreacted furancarboxylic acid were distilled off, and the remainder was dried to recover 100 g of a product.

The product thus recovered was subjected to elemental analysis, and as a result, oxygen seemed to be derived from furan was detected. The product obtained is referred to as “carbon clusters (D)”.

### Preparation Example 5

In 100 g of N,N-dimethylacetamide, 10 g of Epolight 1031S (available from Yuka-Shell Epoxy Co., Ltd.) was dissolved, and 8 g of furoyl dichloride was added. To the resulting solution, 10 g of pyridine was dropwise added, and they were stirred for 3 hours. Then, 150 g of dilute hydrochloric acid was dropwise added to recover a precipitate. The precipitate was dissolved in ethyl acetate, and the solution was washed with water to obtain 13 g of a compound (a).

### Preparation Example 6

In 100 g of N,N-dimethylacetamide, 10 g of an epoxy compound Epolead PB3600 (available from Dicel Chemical Industries, Ltd.) was dissolved, and 10 g of furoyl dichloride was added. To the resulting solution, 9 g of pyridine was dropwise added, and they were stirred for 3 hours. Then, 150 g of dilute hydrochloric acid was dropwise added to recover a precipitate. The precipitate was dissolved in ethyl acetate, and the solution was washed with water to obtain 14 g of a compound (b) wherein a furan ring was introduced into the side chain.

### Preparation Example 7

2.39 g of 4,10-dioxatricyclo[6.3.1.0^{2,7}]dodecane-3,5,9,11-tetraone, 1.55 g of a compound represented by the following formula (7), 1.05 g of diaminodiphenylmethane, 0.1 g of LP-7100 (available from Shinetsu Chemical Industry Co., Ltd.) and 11.5 g of γ-butyrolactone were mixed, and they were reacted at 60° C. for 12 hours in a closed system. Then, 4.2 g of pyridine and 4.3 g of acetic anhydride were added, and reaction was performed at 110° C. for 4 hours. Thereafter, a polymer was precipitated with methanol to recover 4.7 g of the polymer.

Subsequently, 3 g of the polymer was dissolved in 50 g of N,N-dimethylacetamide, and 0.5 g of furoyl dichloride was added. To the resulting solution, 1 g of pyridine was dropwise added, and they were stirred for 3 hours. Then, 70 g of dilute hydrochloric acid was dropwise added to recover 2.7 g of a precipitate. From NMR and IR analyses, it was confirmed that the compound thus recovered had a polyimide structure and a furan ring. This compound is referred to as a “compound (c)”.

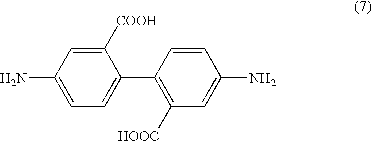

### Preparation Example 8

30 g of methyl methacrylate, 10 g of methacryloyloxybenzyl alcohol, 10 g of benzyl methacrylate, 50 g of styrene, 200 g of propylene glycol monomethyl ether acetate and 1 g of azobisisobutyronitrile were mixed, and they were subjected to radical polymerization reaction at 80° C. for 3 hours. Then, the reaction solution was introduced into a large amount of methanol to recover a polymer. In 10 g of N,N-dimethylacetamide, 5 g of the polymer recovered was dissolved, and 3.5 g of furoyl dichloride was added. To the resulting solution, 3 g of pyridine was dropwise added, and they were stirred for 3 hours. Then, 30 g of dilute hydrochloric acid was dropwise added to recover 2.7 g of a precipitate. This compound is referred to as a “compound (d)”.

### Preparation Example 9

12.0 g of 1,3,3a,4,5,9b-hexahydro-8-methyl-5-(tetrahydro-2,5-dioxo-3-furanyl)-naphtho[1,2-c]furan-1,3-dione, 2.87 g of the compound represented by the aforesaid formula 1-(4), 5.08 g of diaminodiphenylmethane, 0.22 g of furfurylamine and 32.5 g of γ-butyrolactone were mixed, and they were reacted at 60° C. for 12 hours in a closed system. Then, 50.5 g of γ-butyrolactone, 15.2 g of pyridine and 15.3 g of acetic anhydride were added, and reaction was performed at 80° C. for 4 hours. Thereafter, a polymer was precipitated with methanol to recover 19.7 g of the polymer. From NMR and IR analyses, it was confirmed that the compound thus recovered had a polyimide structure and a furan ring. This compound is referred to as a “compound (e)”.

### Example 1

(1) Preparation of Photosensitive Composition

1 g of crude fullerene (available from Honjo Chemical Corporation, containing about 85% of fullerene C₆₀) as a photosensitive agent, which had been previously dissolved in toluene in a concentration of 0.5%, 10 g of a compound (1) represented by the following formula (11) as a heterocyclic ring-containing compound, 50 g of cyclohexanone as a solvent and 12 g of RIKACOAT SN-20 (available from New Japan Chemical Co., Ltd.) as an additive were mixed and stirred, to prepare a photosensitive resin composition. 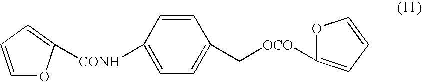
(2) Preparation of Coating Film and Patterning

A silicon wafer was coated with the photosensitive resin composition by means of a spin coater, and the composition was dried at 90° C. for 10 minutes to remove the solvent and thereby form a coating film having a thickness of 5 μm.

Then, the coating film was irradiated with light from a high-pressure mercury lamp through an exposure mask (pattern having opening diameter of 5 μm). The irradiation dose was 100 mJ/cm² (measured value in case of i line (ultraviolet rays having wavelength of 365 nm)). The thin film having been subjected to light exposure was then subjected to dip development for 50 seconds using, as a developing solution, the same solvent as used in the composition. Then, washing with ultra-pure water was carried out. The thin film was observed by a scanning electron microscope to measure a width and a height of a bottom surface having a shape of the section. As a result, the width of the bottom surface was 5 μm±0.5 μm and the height of the bottom surface was 5 μm±1 μm, that is, a resist pattern having high dimensional accuracy was obtained, and the exposure and development were evaluated as “excellent”.

(3) Evaluation of Thin Film Properties

Using a thin film of 5 μm thickness having been subjected to light exposure and development, dielectric constant, resistivity, heat resistance and endurance were measured. As a result, the dielectric constant was 3.1, the resistivity was 10¹² Ω·cm, and as the heat resistance, loss in weight at 300° C. was 3%.

The endurance was evaluated in the following manner. On a silicon wafer having been subjected to copper sputtering, a thin film was formed, and the thin film was subjected to copper sputtering and copper electroplating to prepare a sample having a thin film sandwiched between copper layers. The sample was measured on peel strength before and after PCT (121° C., 100% RH, 2 atm, 168 hrs) to determine reduction in peel strength, and the reduction in peel strength was evaluated as the endurance. The reduction in peel strength was 5%.

Property values required for the practical use are as follows. Any of the measured values satisfied these requirements, so that the practical properties were excellent.

Dielectric constant: <3.5

Resistivity: >10⁹ Ω·cm

Weight in loss at 300° C.: <10%

Reduction in peel strength: <20%

### Examples 2 to 10

A photosensitive composition was prepared in the same manner as in Example 1, except that the components used and the amounts thereof were changed as shown in Table 1. Then, preparation of a coating film, patterning and evaluation of a thin film were carried out in the same manner as in Example 1. The results are set forth in Table 2.

TABLE 1

| | | | | | | Heterocyclic |
|---|---|---|---|---|---|---|
| | | | Heterocyclic ring-containing | | | ring-containing |
| | | | compound | | | compound/photosensitive |
| | Photosensitive agent | | | | Content | agent |
| | Type | Amount | Type | Amount | ratio (%) *1) | molar ratio *2) |
| Ex. 1 | 0.5% toluene solution of | 1 g | compound (1) | 1 g | 29 | 860 |
| | crude fullerene (Honjo | | | | | |
| | Chemical Corporation) | | | | | |
| Ex. 2 | carbon clusters (A) | 5 mg | compound (a), | 1 g, | 21 | 1430 |
| | | | compound (c) | 3 g | | |
| Ex. 3 | carbon clusters (B) | 2 g | compound (b), | 1 g, | 0 | 17 |
| | | | compound (c) | 3 g | | |
| Ex. 4 | carbon clusters (A) | 0.5 g | compound (d) | 20 g | 0 | 43 |
| Ex. 5 | carbon clusters (C) | 3 g | compound (c) | 30 g | 0 | 45 |
| Ex. 6 | carbon clusters (D) | 60 mg | compound (1) | 130 g | 32 | 10030 |
| Ex. 7 | crude fullerene | 1 g, | compound (c) | 2 g | 0 | 2.8 |
| | (Frontier Carbon | 50 mg | | | | |
| | Corporation), carbon | | | | | |
| | clusters (A) | | | | | |
| Ex. 8 | corannulene | 10 mg | compound (b) | 3 g | 0 | 230 |
| Ex. 9 | 0.3% benzaldehyde | 4 g | compound (e) | 1.2 g | 0 | 37 |
| | solution of crude | | | | | |
| | fullerene (Honjo | | | | | |
| | Chemical Corporation) | | | | | |
| Ex. 10 | 0.3% benzaldehyde | 4 g | compound (e) | 1.2 g | 0 | 577 |
| | solution of crude | | | | | |
| | fullerene (Honjo | | | | | |
| | Chemical Corporation) | | | | | |

| | | | Ratio of other resins | |
|---|---|---|---|---|
| | | | to heterocyclic ring- | All solids |
| | | | containing compound | concentration |
| | Solvent | Other components | (part(s) by weight) | (%) |
| Ex. 1 | cyclohexanone | SN-20 12 g, F3-009-01 (Nippon | 290 | 15 |
| | 10 g | Unicar Co. Ltd.) 0.5 g | | |
| Ex. 2 | cyclohexanone | Irgacura 261 (Ciba Specialty | 25 | 31 |
| | 10 g | Chemicals Inc.) 100 mg, | | |
| | | Composeran E102 (Arakawa | | |
| | | Chemical Industries, Ltd.) 1 g | | |
| | | (50% solution) | | |
| Ex. 3 | propylene glycol | benzophenone 0.1 g | 0 | 16.6 |
| | monomethyl | | | |
| | ether acetate | | | |
| | 20 g | | | |
| Ex. 4 | cyclohexanone | X-22-8917 (Shinetsu Chemical | 400 | 37 |
| | 100 g | Industry Co., Ltd.) 40 g | | |
| Ex. 5 | γ-butyrolactone | | 0 | 23 |
| | 100 g | | | |
| Ex. 6 | cyclohexanone | SN-20 70 g | 208 | 17 |
| | 2000 g | x-22-8084 (Shinetsu Chemical | | |
| | | Industry Co., Ltd.) 200 g | | |
| Ex. 7 | ethyl lactate | Irgacure 261 (Ciba Specialty | 50 | 45 |
| | 5 g | Chemicals Inc.) 100 mg, | | |
| | | Epolead GT401 (Dicel Chemical | | |
| | | Industries, Ltd.)1 g | | |
| Ex. 8 | propylene glycol | γ-cyclodextrin 100 mg, | 267 | 31 |
| | monomethyl | X-22-8917 (Shinetsu Chemical | | |
| | ether acetate | Industry Co., Ltd.) 8 g | | |
| | 20 g | | | |
| Ex. 9 | γ-butyrolactone | 18% cyclohexanone solution of X- | 660 | 15 |
| | 4 g | 22-8917 (Shinetsu Chemical | | |
| | | Industry Co., Ltd.) 8 g | | |
| Ex. 10 | cyclohexanone | 18% cyclohexanone solution of X- | 37.5 | 15 |
| | 4 g | 22-8917 (Shinetsu Chemical | | |
| | | Industry Co., Ltd.) 4 g, | | |
| | | Hitafuran VF954K (Hitachi | | |
| | | Chemical Co., Ltd., furan resin) | | |
| | | 0.72 g | | |

*1): Ratio of low-molecular heterocyclic ring-containing compound to all solids
*2): The number of moles of the photosensitive agent is a value calculated based on the assumption that all of the photosensitive agent is a C60 pure product. The amount of furan ring was calculated based on the amount of the furan compound used for the synthesis.

TABLE 2

| | 5μ | | | Loss in | Reduction in |
|---|---|---|---|---|---|
| | Patterning | Dielectric | Resistivity | weight | peel strength |
| | properties | constant | (Ω · cm) | (%) | (%) |
| Ex. 1 | Excellent | 3.1 | 10¹² | 3 | 5 |
| Ex. 2 | Excellent | 3.3 | 10¹² | 7 | 4 |
| Ex. 3 | Excellent | 3 | 10¹² | 8 | 10 |
| Ex. 4 | Excellent | 3.4 | 10¹¹ | 8 | 5 |
| Ex. 5 | Excellent | 3 | 10¹² | 1 | 10 |
| Ex. 6 | Excellent | 3.4 | 10¹⁰ | 9 | 18 |
| Ex. 7 | Excellent | 2.8 | 10¹³ | 3 | 6 |
| Ex. 8 | Excellent | 3.4 | 10¹⁰ | 9 | 6 |
| Ex. 9 | Excellent | 3.3 | 10¹⁰ | 7 | 6 |
| Ex. 10 | Excellent | 3.5 | 10¹⁰ | 9 | 6 |

### Comparative Example 1

1 g of crude fullerene (available from Frontier Carbon Corporation, containing about 60% of fullerene C₆₀) as a photosensitive agent, which had been previously dissolved in toluene in a concentration of 0.5%, 10 g of the compound (b) as a heterocyclic ring-containing compound and 50 g of dichlorobenzene as a solvent were mixed and stirred, to prepare a photosensitive resin composition.

Using the photosensitive resin composition, a film of 5 μm thickness was formed on a substrate in the same manner as in Example 1. Then, the film was subjected to light exposure and development in the same manner as in Example 1. As a result, the coating film was entirely dissolved in the developing solution, and it was found that at an irradiation dose of 100 mJ/cm², photo-curing of the coating film did not proceed sufficiently.

### Comparative Example 2

1 g of crude fullerene (available from Honjo Chemical Corporation, containing about 85% of fullerene C₆₀) as a photosensitive agent, which had been previously dissolved in dichlorobenzene in a concentration of 0.7%, 10 g of the compound (b) as a heterocyclic ring-containing compound and 50 g of propylene glycol monomethyl ether acetate as a solvent were mixed and stirred, to prepare a photosensitive resin composition.

Using the photosensitive resin composition, an attempt to form a coating film on a substrate was made in the same manner as in Example 1, but fullerene was precipitated, and a uniform coating film was not obtained.

### Example 11

In 50 ml of N-methyl-2-pyrrolidone, 8.47 g (0.0392 mol) of 3,3′-diamino-4,4′-dihydroxybiphenyl and 8.78 g (0.0392 mol) of 4,10-dioxatricyclo[6.3.1.0^{2,7}]dodecane-3,5,9,11-tetraone were stirred at 60° C., to obtain a solution of polyamic acid.

Then, to the reaction mixture were added 15.5 g of pyridine and 16 g of acetic anhydride, and reaction was further performed at 110° C. for 5 hours. Thereafter, the resulting solution was introduced into a large amount of methanol to recover 15 g of soluble polyimide.

Separately, 5.00 g (0.0510 mol) of furfuryl alcohol was dissolved in 50 ml of tetrahydrofuran, and to the resulting solution was dropwise added 4.90 g (0.0181 mol) of phosphorus tribromide with keeping the temperature at 0° C. After stirring for about 2 hours, water was added, and an organic component was extracted twice by the use of 100 ml of ether. The ether layer was washed with sodium hydrogencarbonate, then 30 g of molecular sieves were added, and the mixture was dried for one night and then filtered to obtain an ether solution of furfuryl bromide. The resulting solution was subjected to analyses of FT-IR, ¹H-NMR and ¹³C-NMR, and as a result, the reaction product proved to be furfuryl bromide.

Subsequently, 15 g of the soluble polyimide was added to 150 ml of γ-butyrolactone to dissolve the polyimide in γ-butyrolactone. To the resulting solution, the ether solution containing 7.70 g of furyfuryl bromide and 6.50 g of potassium carbonate were added, and they were stirred at 80° C. for about 2 hours.

Then, resolidification-precipitation was carried out by the use of methanol, and the precipitate was vacuum dried to obtain 16.5 g of polyamic acid having a furan structure. The polyamic acid was subjected to ¹H-NMR analysis, and as a result, it was found that 70% by mol of diamine structure units in the polyamic acid had been replaced with furfuryl groups. The polyimide had a molecular weight of about 35,000. Then, 0.75 g of high-purity fullerene C₆₀ (99.98% by weight, available from Term), 10.0 g of the furfuryl group-partially substituted polyimide and 5 g of X-22-8917 (available from Shinetsu Chemical Industry Co., Ltd.) were dissolved in 50 ml of γ-butyrolactone/1.1.2.2-tetrachloroethane (70/30, by volume) to give a homogeneous solution. The solution was filtered through a filter having a pore size of 0.1 μm to obtain a photo-curing resin solution.

Then, a quartz type image fiber having a diameter of 500 μm and a length of 3 cm used for the image transmission was dipped in the photo-curing resin solution and taken out at a rate of 1 cm/min to perform dip coating.

The fiber thus coated was dried at 90° C. for 10 minutes, then irradiated with visible light (irradiation dose in terms of ultraviolet rays having wavelength of 365 nm: 100 mJ/cm²) from a high-pressure mercury lamp and dried in a circular oven at 180° C. for 1 hour to cure the resin. Thus, an image fiber coated with polyimide of 30 μm thickness having a film thickness dispersion width of 0.7 μm was prepared.

Then, 20 polyimide-coated fibers prepared above were subjected to boiling extraction with 1 ml of an isotonic sodium chloride solution for 50 hours. As a result, the value of acute toxicity (oral administration, mouse, LD₅₀) of the liquid did not change from that of the isotonic sodium chloride solution before extraction, and toxicity was not observed.

Further, even after the image fibers were kept under heating at 300° C. for 1 hour, the loss in weight was not more than 3%, and they had satisfactory heat endurance.

As described above, the time from application of the resin solution to completion of polyimide coating was a little less than 2 hours, and it was possible to prepare a large number of samples simultaneously.

### Example 12

Polyimide coating was carried out in the same manner as in Example 11, except that the rate to take out the image fiber from the photo-curing resin solution was changed to 5 cm/min. As a result, an image fiber coated with polyimide of 10 μm thickness having a film thickness dispersion width of 0.2 μm was prepared.

### Example 13

In 25 ml of N-methyl-2-pyrrolidone, 3.2 g (0.0078 mol) of 2,2-bis[4-(4-aminophenoxy)phenyl]propane, 3.24 g (0.0078 mol) of diamine (x) represented by the following formula (x) and 3.56 g (0.016 mol) of 4,10-dioxatricyclo[6.3.1.0^{2,7}]dodecane-3,5,9,11-tetraone were stirred at 60° C., to obtain a solution of polyamic acid.

Then, to the reaction mixture were added 6.3 g of pyridine and 6.5 g of acetic anhydride, and reaction was further performed at 110° C. for 5 hours. Thereafter, the resulting solution was introduced into a large amount of methanol to recover 8 g of soluble polyimide.

As a result of ¹H-NMR analysis, a furan ring derived from the diamine (x) was confirmed, and the resulting polyimide proved to be polyimide having a furan ring in the side chain.

The polyimide had a molecular weight of about 30,000.

Then, 0.75 g of crude fullerene (available from Frontier Carbon Corporation), 10.0 g of the furfuryl group-partially substituted polyimide and 5 g of X-22-8917 (available from Shinetsu Chemical Industry Co., Ltd.) were dissolved in 20 ml of γ-butyrolactone/1.1.2.2-tetrachloroethane (70/30, by volume) to give a homogeneous solution. The solution was filtered through a filter having a pore size of 0.1 μm to obtain a photo-curing resin solution.

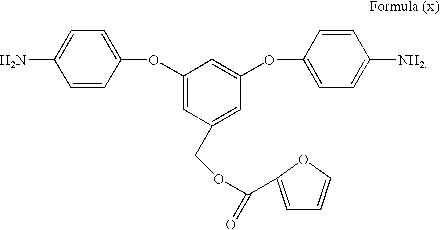

Using the photo-curing resin solution, a circle of 1 mm diameter (line width: 50 μm) was continuously formed by a photo-molding machine “Solid Creator JSC-2000” (Sony Corporation) equipped with an argon ion laser (wavelength: 351 nm, 364 nm) as an irradiation light source under the conditions of a laser light intensity of 40 mW on a liquid level, a scanning rate of 100 cm/sec and a cured resin layer thickness of 0.2 mm, to obtain a polyimide tube having a diameter of 1 mm, a thickness of 50 μm and a length of 3 cm.

The polyimide tube was baked at 150° C. for 1 hour in a clean oven.

Then, similarly to Example 11, 20 tubes were subjected to boiling extraction with 1 ml of an isotonic sodium chloride solution for 50 hours, and acute toxicity (oral administration, mouse, LD₅₀) of the liquid was examined. As a result, toxicity was not observed.

### Example 14

In 25 ml of N-methyl-2-pyrrolidone, 6.4 g (0.0156 mol) of 2,2-bis[4-(4-aminophenoxy)phenyl]propane and 3.56 g (0.016 mol) of 4,10-dioxatricyclo[6.3.1.0^{2,7}]dodecane-3,5,9,11-tetraone were stirred at 60° C., to obtain a solution of polyamic acid.

Then, to the reaction mixture were added 6.3 g of pyridine and 6.5 g of acetic anhydride, and reaction was further performed at 110° C. for 5 hours. Thereafter, the resulting solution was introduced into a large amount of methanol to recover 8 g of soluble polyimide.

Then, 0.75 g of crude fullerene (available from Frontier Carbon Corporation), 10.0 g of the soluble polyimide and 2 g of the same compound (1) represented by the formula (11) as used in Example 1, which had been synthesized from p-aminobenzyl alcohol and furoyl dichloride, were dissolved in 20 ml of γ-butyrolactone/1.1.2.2-tetrachloroethane (70/30, by volume) to give a homogeneous solution.

The solution was filtered through a filter having a pore size of 0.1 μm to obtain a photo-curing resin solution.

The resin solution was applied on a silicon wafer by means of a spin coater and dried at 90° C., for 10 minutes to remove the solvent and thereby form a coating film having a thickness of 5 μm.

Then, the coating film was irradiated with light from a high-pressure mercury lamp through an exposure mask (pattern having opening diameter of 5 μm). The irradiation dose was 100 mJ/cm² (measured value in case of i line (ultraviolet rays having wavelength of 365 nm)). The thin film having been subjected to light exposure was then subjected to dip development for 50 seconds using, as a developing solution, the same solvent as used in the composition. Then, washing with ultra-pure water was carried out.

The thin film was observed by a scanning electron microscope to measure a width and a height of a bottom surface having a shape of the section. As a result, the width of the bottom surface was 5 μm±0.5 μm and the height of the bottom surface was 5±1 μm, that is, a pattern of a polyimide cured product having high dimensional accuracy was obtained.

### Example 15

In 20 ml of γ-butyrolactone/benzaldehyde (50/50, by volume), 0.75 g of crude fullerene (available from Frontier Carbon Corporation), 10.0 g of the soluble polyimide (compound (e)) synthesized in Preparation Example 9 and 2 g of a furan resin (Hitafuran VF-954K, available from Hitachi Chemical Co., Ltd.) were dissolved, to give a homogeneous solution.

The solution was filtered through a filter having a pore size of 0.1 μm to obtain a photo-curing resin solution.

The resin solution was applied on a silicon wafer by means of a spin coater and dried at 90° C. for 10 minutes to remove the solvent and thereby form a coating film having a thickness of 1.5 μm.

Then, the coating film was irradiated with light from a high-pressure mercury lamp through an exposure mask (pattern having opening diameter of 5 μm). The irradiation dose was 100 mJ/cm² (measured value in case of i line (ultraviolet rays having wavelength of 365 nm)). The thin film having been subjected to light exposure was then subjected to dip development for 10 seconds using, as a developing solution, the same solvent as used in the composition. Then, washing with ultra-pure water was carried out.

The thin film was observed by a scanning electron microscope to measure a width and a height of a bottom surface having a shape of the section. As a result, the width of the bottom surface was 5 μm±0.5 μm and the height of the bottom surface was 5 μm±1 μm, that is, a pattern of a polyimide cured product having high dimensional accuracy was obtained. Then, 10 substrates of 1 cm square each having been provided with a pattern were subjected to boiling extraction with 1 ml of an isotonic sodium chloride solution for 50 hours, and acute toxicity (oral administration, mouse, LD₅₀) of the liquid was examined. As a result, the property value of the liquid did not change from that of the isotonic sodium chloride solution before extraction, and toxicity was not observed.

### Comparative Example 3

In accordance with Example 11 described in Japanese Patent Laid-Open Publication No. 293082/2001, 1.73 g of N-silylated diamine was dissolved in 12.5 ml of N,N-dimethylacetamide (DMAc). Then, 1.09 g of pyromellitic anhydride (PMDA) was added at 5° C., and the resulting mixture was stirred at 20° C. for 1 hour and then at 50° C. for 12 hours in a stream of nitrogen to synthesize polyamic acid. To this polymerization solution, 0.14 g of montmorillonite into which alkylammonium ion had been intercalated was added, and it was sufficiently dispersed in the solution to prepare a polyamic acid solution.

A quartz type image fiber having a diameter of 500 μm and a length of 3 cm was dipped in the polyamic acid solution and taken out at a rate of 1 cm/min to perform dip coating.

The fiber thus taken out was vacuum dried at room temperature for one day, at 60° C. for 12 hours, at 100° C. for 12 hours, at 150° C. for 6 hours and at 200° C. for 6 hours, and then heated at 300° C. for 2 hours in a stream of nitrogen to obtain an image fiber coated with polyimide.

The thickness of the polyimide layer was 5 μm, so that in order to obtain a desired thickness of 30 μm, it was necessary to repeat the above operation 6 times.

### Comparative Example 4

In accordance with Example 11 described in Japanese Patent Laid-Open Publication No. 95735/2002, pyromellitic anhydride and 4,4′-diaminodiphenylmethane were vacuum deposited on a surface of a quartz type image fiber having a diameter of 500 μm and a length of 3 cm to form a deposited film of 0.1 μm.

Separately, blocked isocyanate (trade name: Elastron H-8) and polyethylene glycol (molecular weight: 100,000) were mixed in a weight ratio of 1:10 to prepare a 10% aqueous solution. The 10% aqueous solution was applied on the deposited film of the above fiber and then dried by a hot air circular dryer at 50° C. for 2 hours, followed by heat treatment at 120° C. for 20 minutes.

The polyimide-based resin film formed as above had an average film thickness of only 0.4 μm.

It can be seen from Examples 11 to 15 and Comparative Examples 3 and 4 that in the present invention, the thickness of the polyimide film can be freely determined by the coating conditions and the like. Further, it can be seen that in the present invention, the number of steps for the film formation is smaller and the film formation can be much more efficiently carried out as compared with hitherto known processes such as deposition process and polyamic acid process.

Moreover, the present invention has proved to be an epoch-making process or material capable of erasing a fear of evil influence on the organism, because no toxicity was detected from the polyimide film formed by the process of the present invention though the film was a photo-curing material.

1. A photo-curing composition comprising:
(A) a carbon cluster and/or its derivative, having a photosensitizing function,
(B) a compound having plural heterocyclic rings in a molecule,
and if necessary,
(C) a photo-insensitive resin.

2. The photo-curing composition as claimed in claim 1, which contains a compound having a siloxane bond in a molecule.

3. The photo-curing composition as claimed in claim 2, wherein at least one of the carbon cluster and/or its derivative (A), the compound (B) having heterocyclic rings in a molecule and the photo-insensitive resin (C) contains a compound having a siloxane bond in a molecule.

4. The photo-curing composition as claimed in claim 2 or 3, wherein the compound having a siloxane bond in a molecule is contained in an amount of 1 to 30% by weight in the photo-curing composition except a solvent.

5. The photo-curing composition as claimed in any one of claims 1 to 4, wherein the carbon cluster and/or its derivative (A) contains one or more substances selected from the group consisting of fullerene, carbon nanotube, carbon nanohorn and their derivatives.

6. The photo-curing composition as claimed in any one of claims 1 to 5, wherein the carbon cluster and/or its derivative (A) contains one or more substances selected from the group consisting of fullerene and fullerene derivatives.

7. The photo-curing composition as claimed in any one of claims 1 to 6, wherein the carbon cluster and/or its derivative (A) contains chemically modified fullerene.

8. The photo-curing composition as claimed in any one of claims 1 to 7, wherein the carbon cluster and/or its derivative (A) contains a derivative of a carbon cluster having a heterocyclic ring.

9. The photo-curing composition as claimed in any one of claims 1 to 8, wherein the total amount of fullerene and a fullerene derivative is in the range of 50 to 100 parts by weight in 100 parts by weight of the carbon cluster and/or its derivative (A).

10. The photo-curing composition as claimed in any one of claims 1 to 9, wherein the compound (B) having plural heterocyclic rings in a molecule contains a polymer having a heterocyclic ring in a side chain.

11. The photo-curing composition as claimed in claim 10, wherein the polymer having a heterocyclic ring in a side chain is a polymer obtained by allowing a polymer selected from the group consisting of an acrylic-based polymer, an epoxy-based polymer and a polyimide-based polymer to react with a compound having a heterocyclic ring.

12. The photo-curing composition as claimed in claim 10, wherein the polymer having a heterocyclic ring in a side chain is a polymer which is obtained by allowing a polyimide-based polymer to react with a compound having a heterocyclic ring and has a heterocyclic ring at least one end.

13. The photo-curing composition as claimed in any one of claims 1 to 12, wherein the compound (B) having plural heterocyclic rings in a molecule contains a compound having a molecular weight of 200 to 100,000.

14. The photo-curing composition as claimed in any one of claims 1 to 13, wherein the compound (B) having plural heterocyclic rings in a molecule is a compound having furan rings and/or thiophene rings as the heterocyclic rings.

15. The photo-curing composition as claimed in any one of claims 1 to 14, wherein the compound (B) having plural heterocyclic rings in a molecule contains a heterocyclic ring-containing polyimide resin.

16. The photo-curing resin composition as claimed in any one of claims 1 to 15, wherein the photo-insensitive resin (C) contains a polyimide resin.

17. A negative photoresist composition comprising the photo-curing composition of any one of claims 1 to 17.

18. A process for producing a medical instrument, comprising applying the photo-curing composition of claim 15 or 16 on a substrate and then irradiating the composition with light to form a coating layer having a thickness of 1 to 1000 μm.

19. A medical instrument obtained by the process for producing a medical instrument of claim 18.
